(19) United States
(12) Patent Application Publication
(10) Pub. No.: US 2025/0391398 A1
(43) Pub. Date: Dec. 25, 2025

(54) MULTI-THREADING TECHNIQUES FOR TEXT-TO-SPEECH INFERENCE

(71) Applicant: Oracle International Corporation, Redwood Shores, CA (US)

(72) Inventors: Vishal Gourav, Bengaluru (IN); Ankit Tyagi, Bangalore (IN); Phanindra Vittal Rao Mankale, Bengaluru (IN)

(73) Assignee: Oracle International Corporation, Redwood Shores, CA (US)

(21) Appl. No.: 19/049,771

(22) Filed: Feb. 10, 2025

(30) Foreign Application Priority Data
Jun. 25, 2024 (IN) 202141048572

(51) Int. Cl. G10L 13/08

(52) U.S. Cl. CPC G10L 13/08

(57) ABSTRACT

Techniques discussed herein relate to reducing latency in a Text-To-Speech processing pipeline. A request may be received requesting a speech waveform corresponding to input text provided in the request. The input text may be processed using a set of text preprocessing operations to generate a set of sound units. The set of sound units may be provided to an acoustic model to generate sound frequency data which may be divided into a number of smaller sound frequency data segments corresponding to the number of available computing threads. Each thread may be configured to provide a respective sound frequency data segment to a neural network as input to generate a plurality of speech waveforms. The plurality of speech waveforms may be combined to generate the speech waveform requested. The combined speech waveform may be provided in response to the request.

### CROSS-REFERENCE TO RELATED APPLICATIONS

This non-provisional application claims priority to Indian Provisional Patent Ser. No. 202141048572, filed on Jun. 25, 2024, entitled “Multi-Threading Techniques for Text-To-Speech Inference,” the disclosure of which is herein incorporated by reference in its entirety for all purposes.

### BACKGROUND

Text-To-Speech (TTS) technology is one of the most sought after technology in today's fast moving Artificial Intelligence world. Two parameters that make a service that supports TTS stand apart are the naturalness of the audio generated and the degree of latency. Achieving both natural sounding output and low latency is difficult. For services that have achieved a natural sounding output, the goal is to reduce inference processing time without deteriorating the quality of the audio output. Embodiments described herein address these and other problems, individually and collectively.

### BRIEF SUMMARY

Embodiments of the present disclosure relate to providing, using multi-threading techniques, reduced inference time latency while maintaining audio output quality of a Text-To-Speech processing pipeline.

At least one embodiment is directed to a computer-implemented method (“a method”). The method may comprise receiving, by a computing system configured to execute a Text-To-Speech processing pipeline, a request comprising input text for which corresponding speech is requested. The method may comprise generating, by the computing system, a plurality of sound frequency data segments. In some embodiments, the plurality of sound frequency data segments may be generated based at least in part on dividing sound frequency data previously generated for the input text by an acoustic model of the Text-To-Speech processing pipeline. The method may comprise generating, by the computing system utilizing the plurality of computing threads, a plurality of speech waveforms from the plurality of sound frequency data segments based at least in part on providing each sound frequency data segment of the plurality of sound frequency data segments to a respective neural network of a plurality of neural networks. The method may comprise generating, by the computing system, a combined speech waveform based at least in part on combining the plurality of speech waveforms that were generated by the plurality of neural networks. The method may comprise providing, by the computing system, the combined speech waveform in response to the request.

In some embodiments, the method may comprise generating a set of sound units from the input text. The set of sound units may be generated based at least in part on executing a set of preprocessing tasks comprising at least one of a text normalization process or a grapheme-to-phoneme conversion process. In some embodiments, the set of sound units are a set of phonemes.

In some embodiments, the plurality of neural networks are a plurality of instances of a neural vocoder. The neural vocoder may be a machine-learning model previous trained to take a Mel spectrogram as input and generate a corresponding speech waveform as output, the corresponding speech waveform, when played, comprising corresponding speech of at least a portion of the input text.

In some embodiments, each sound frequency data segment of the plurality of sound frequency data segments is provided to the corresponding neural network of the plurality of neural networks utilizing a respective computing thread of the plurality of computing threads. In some embodiments, providing each sound frequency data segment utilizing the respective computing thread reduces an overall latency of executing the Text-To-Speech processing pipeline.

In some embodiments, the sound frequency data is a Mel spectrogram generated by the acoustic model. The plurality of sound frequency data segments may comprise a plurality of Mel spectrograms obtained based at least in part on dividing the Mel spectrogram generated by the acoustic model into segments.

In some embodiments, a quantity of the plurality of computing threads is identified prior to initiating the plurality of computing threads. The quantity may be identified based at least in part on a number or type of the one or more processors that are utilized by the computing system.

At least one embodiment is directed to a computer-implemented method (“a method”). The method may comprise receiving, by a computing system configured to execute a Text-To-Speech processing pipeline, a request comprising input text for which corresponding speech is requested. The method may comprise transform, by the computing system, the input text into a set of sound units based at least in part on executing a set of preprocessing tasks. The method may comprise generating, by the computing system, sound frequency data based at least in part on providing the set of sound units to an acoustic model of the Text-To-Speech processing pipeline. The method may comprise dividing, by the computing system, the sound frequency data into a plurality of sound frequency data segments. The method may comprise generating, by the computing system utilizing a plurality of computing threads, a plurality of speech waveforms based at least in part on providing each sound frequency data segment of the plurality of sound frequency data segments to a corresponding neural network of a plurality of neural networks of the Text-To-Speech processing pipeline. The method may comprise generating, by the computing system, a combined speech waveform corresponding to the input text based at least in part on combining the plurality of speech waveforms generated by the plurality of neural networks. The method may comprise providing, by the computing system, the combined speech waveform in response to the request.

In some embodiments, the set of preprocessing tasks comprises at least one of a text normalization process or a grapheme-to-phoneme conversion process.

In some embodiments, the plurality of neural networks are a plurality of instances of a neural vocoder. The neural vocoder may be a machine-learning model that has been previously trained to take a Mel spectrogram as input and to generate a corresponding speech waveform as output. In some embodiments, the corresponding speech waveform, when played, comprise corresponding speech of at least a portion of the input text.

In some embodiments, utilizing the plurality of computing threads to provide each sound frequency data segment of the plurality of sound frequency data segments to a corresponding neural network of the plurality of neural networks optimally reduces an overall latency of executing the Text-To-Speech processing pipeline.

In some embodiments, the set of sound units are a set of phonemes.

In some embodiments, the sound frequency data is a Mel spectrogram, and the plurality of sound frequency data segments is a plurality of Mel spectrograms obtained based at least in part on dividing the Mel spectrogram.

In some embodiments, a quantity of the plurality of computing threads is based at least in part on a number or type of one or more processors that are accessible to the computing system.

In some embodiments, a system is disclosed. The system may be configured to execute a Text-To-Speech processing pipeline. In some embodiments, the system may comprise one or more processors and one or more non-transitory memories storing computer-readable instructions that, when executed, cause the one or more processors to perform any suitable operations of any method disclosed herein.

In some embodiments, non-transitory computer-readable medium is disclosed. The non-transitory computer-readable medium may be configured to store computer-executable instructions that, when executed by a computer system configured to execute a Text-To-Speech processing pipeline, causes the computer system to perform any suitable operations of any method disclosed herein.

### BRIEF DESCRIPTION OF THE DRAWINGS

FIG. 1 is a block diagram illustrating an example Text-To-Speech processing pipeline, in accordance with at least one embodiment;

FIG. 2 is a block diagram illustrating first example of a multi-threading approach to performing Text-To-Speech processing, in accordance with at least one embodiment;

FIG. 3 is a block diagram illustrating a second example of a multi-threading approach to performing Text-To-Speech processing, in accordance with at least one embodiment;

FIG. 4 is a block diagram illustrating a third example of a multi-threading approach to performing Text-To-Speech processing, in accordance with at least one embodiment;

FIG. 5 is a block diagram illustrating a fourth example of a multi-threading approach to performing Text-To-Speech processing, in accordance with at least one embodiment;

FIG. 6 is a table illustrating example inference times for a number of multi-threading use cases, in accordance with at least one embodiment;

FIG. 7 is a block diagram illustrating an example method for reducing latency in Text-To-Speech processing, in accordance with at least one embodiment.

FIG. 8 is a block diagram illustrating another example method for reducing latency in Text-To-Speech processing, in accordance with at least one embodiment.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Conventionally, the total inference time for Text-To-Speech systems is linearly proportional to the number of characters in the input text. Previous attempts to reduce the total inference time of TTS systems have negatively impacted the quality of audio produced. The disclosed techniques provide a multi-threading approach in which multiple threads are utilized in parallel to perform the processing of at least one level of a TTS processing pipeline. Additionally, the disclosed techniques enable an optimal number of threads to be determined. By utilizing the techniques disclosed herein, the customer perceived latency (CPL) (i.e., a total time taken from the time a customer submits text to the service to the time they receive an audio file for the text returned) may be significantly reduced without deteriorating the quality of the output audio.

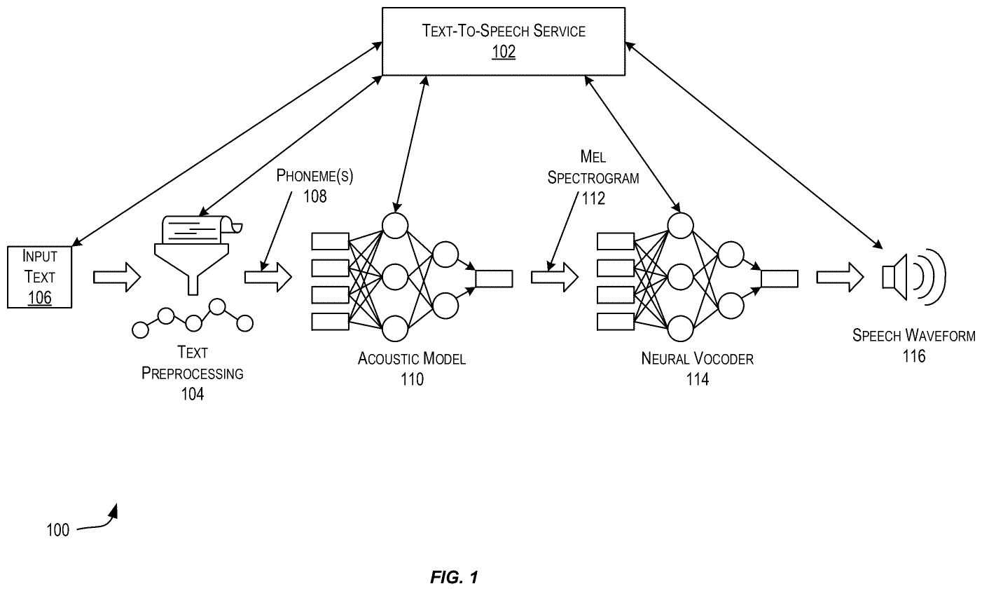

FIG. 1 is a block diagram illustrating an example Text-To-Speech (TTS) processing pipeline 100, in accordance with at least one embodiment. The operations discussed in connection to the TTS processing pipeline 100 may be executed, at least in part, by the Text-To-Speech (TTS) service 102. The TTS service 102 may be configured to interact with one or more other systems to cause each portion of the TTS processing pipeline 100 to be executed. In some embodiments, the TTS service 102 may be configured to directly invoke any suitable portion of the TTS pipeline 102 based at least in part on providing input to a module of the TTS processing pipeline 102, executing a function call, transmitting data via an application programming interface, or the like. In some embodiments, the TTS Service 102 may include modules or models that provide any suitable portion of the TTS processing pipeline 100.

In some embodiments, the TTS processing pipeline 102 may include performing text preprocessing operations (e.g., text preprocessing 104) that prepare input text (e.g., input text 106) to be provided to an acoustic model of the TTS processing pipeline 102 (e.g., acoustic model 108. Text preprocessing 104 may include executing a Speech Synthesis Markup Language (SSML) parse of input text 106. The SSML parser (e.g., the TTS service 102 or another module) may be configured to mark the input text 106 with SSML tags that prepare the text for synthetic audio generation. Text preprocessing 104 may include any suitable operations corresponding to text normalization and phonemic transcription. Text normalization may include any suitable form of disambiguating and expanding the natural language and/or non-standard words (e.g., dates, currencies, abbreviations, etc.) of input text 106. In some embodiments, text normalization may include generating a sequence of graphemes (letters that represent sounds in a written language). Text preprocessing 104 may include executing operations associated with phonemic transaction in which a sequence of graphemes are transcribed into a sequence of phonemes. Graphemes and phonemes are example units of sound. Phonemes are the smallest unit of sound that can distinguish one word from another.

The sequence of phoneme(s) (e.g., Phoneme(s) 108) resulting from execution of text preprocessing 104 may be provided to an acoustic model (e.g., acoustic model 110) as input. The acoustic model may be a machine-learning model that has previously been trained to take a set of phoneme(s) as input and provide a corresponding Mel spectrogram (e.g., Mel spectrogram 112) as output. A Mel spectrogram may indicate frequency content of an audio signal over time. In some embodiments, the acoustic model may be trained from a set of texts and the Mel spectrogram of audio recordings corresponding to the texts. The resulting Mel spectrogram (e.g., Mel spectrogram 112) may be provided as input to neural vocoder 114.

In some embodiment, neural vocoder 114 may be an example of a deep-learning neural network that has been previously trained to synthesize audio waveforms from acoustic features such as Mel spectrogram representations of an audio signal. In some embodiments, speech waveform 116 may generated by neural vocoder 114 as output based at least in part on being provided Mel spectrogram 112 as input.

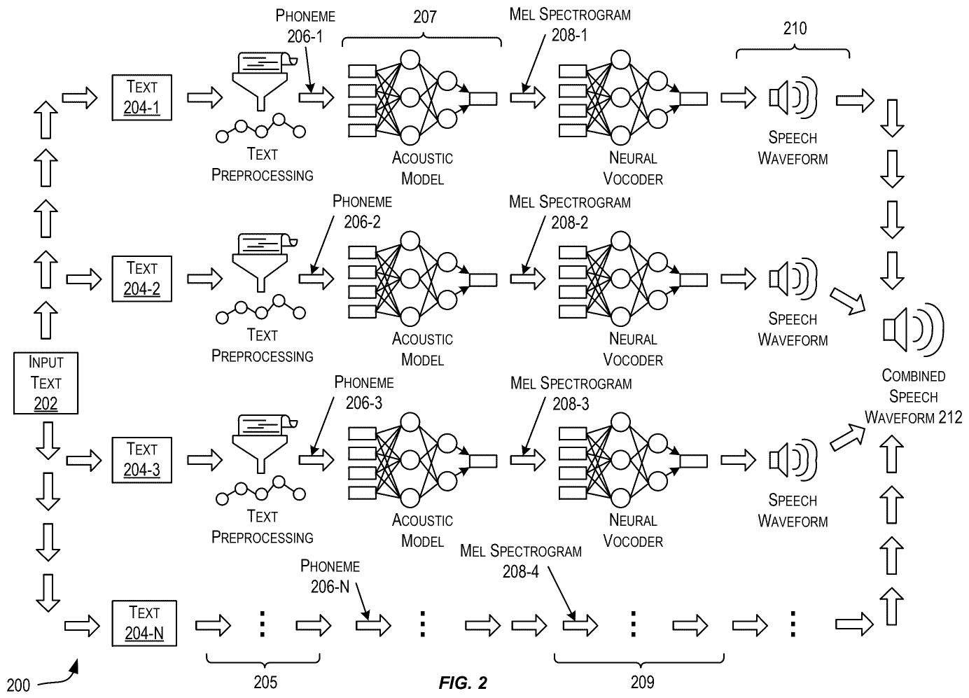

FIG. 2 is a block diagram illustrating a first example of a multi-threading approach 200 to performing Text-To-Speech processing, in accordance with at least one embodiment. The operations discussed in connection with FIG. 2 may be performed by the Text-To-Speech service 102 of FIG. 1. In some embodiments, input text 202 (e.g., an example of input text 106 of FIG. 1) may be split into segments (e.g., text 204-1, text 204-2, text 204-3, text 204-N, collectively referred to as “text segments 204”). As a non-limiting example, input text 202 may be segmented in text segments 204 based at least in part on punctuation (e.g., periods, question marks, exclamation marks, etc.).

The TTS service 102 may generate/start any suitable number of threads (e.g., separate processes) that may individually provide one of the text segments 204 to a corresponding text preprocessing module that is configured to executing operations corresponding to text preprocessing 205 (e.g., text preprocessing 104 of FIG. 1) to generate Phonemes 206-1, 206-2, 206-3, 206-N (collectively referred to as “Phonemes 206). Each thread may be configured to provide a resulting set of phonemes to a corresponding acoustic model (e.g., acoustic models 207, each an example of the acoustic model 110 of FIG. 1) as input. Mel spectrogram 208-1, 208-2, 208-3, and 201-N (collectively referred to as “Mel spectrograms 208”) may individually be provided as output by each acoustic model.

Each thread may provide one of Mel spectrogram 208 to a corresponding neural vocoder (e.g., neural vocoders 209, each an example of neural vocoder 114 of FIG. 1) to generate speech waveforms 210. The speech waveforms 210 may be combined to generate combined speech waveform 212.

The results of employing multi-threading approach 200 appeared promising as there was a reduction in overall processing time by 10%, when using 4 threads. But the pauses between the joined segments (e.g., speech waveforms 210) sounded monotonous and robotic (e.g., it had lost a lot of the human voice qualities that the TTS processing pipeline 100 was known to generate).

On further analysis, it was observed that when the input contained a very large sentence, the segment including that long sentence will take longer to process than the other smaller text segments, leading to reduced performance gain. Said another way, the total inference time for multi-threading approach 200 would always be equal to the inference time needed to generate a speech waveform for the longest text segment of text segments 204.

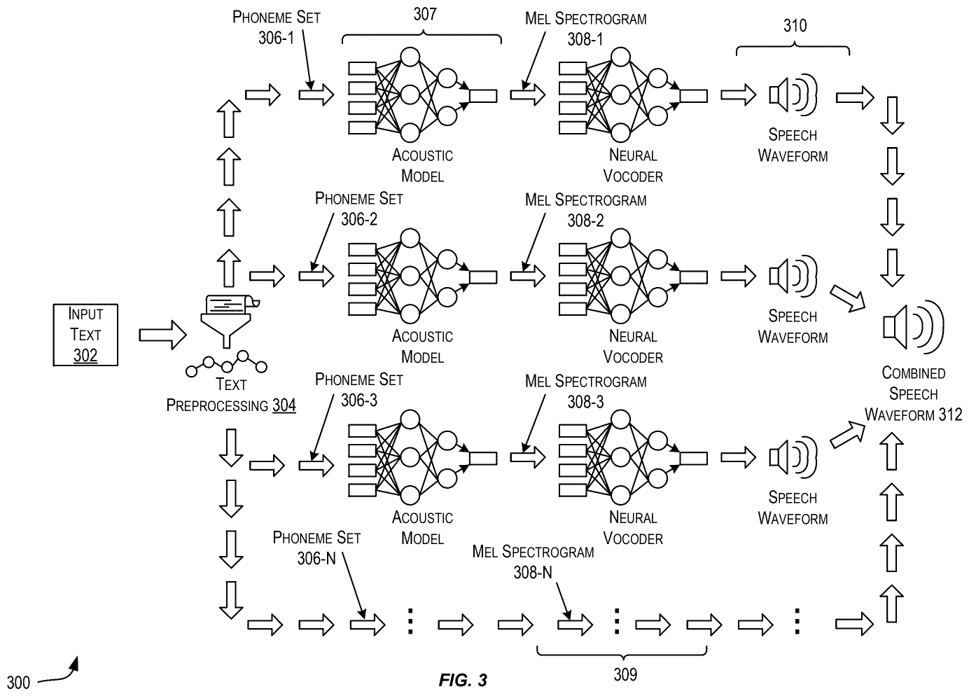

FIG. 3 is a block diagram illustrating a second example of a multi-threading approach 300 to performing Text-To-Speech processing, in accordance with at least one embodiment. The operations discussed in connection with FIG. 3 may be performed by the Text-To-Speech service 102 of FIG. 1. In this example, the preprocessing step may be performed serially, that is, input text 302 may be subjected to text preprocessing 304 (e.g., an example of the operations discussed in connection with text preprocessing 104 of FIG. 1) without being segmented as discussed in FIG. 2.

In some embodiments, the output of text preprocessing 304 may be an initial set of phonemes. This initial set of phonemes may be segmented into equal sized sets (e.g., sets that have the same number of phonemes or, for a set of phonemes that includes an odd number of phonemes, one phoneme segment may include one additional phoneme) including phoneme sets 306-1, 306-2, 306-3, and 306-N, collectively referred to as “phoneme sets 306.”

TTS service 102 may generate/start any suitable number of threads (e.g., separate processes) that may individually provide each set of phoneme sets 306 to a corresponding acoustic model (e.g., acoustic models 307, each an example of the acoustic model 110 of FIG. 1) as input. Mel spectrogram 308-1, 308-2, 308-3, and 308-N (collectively referred to as “Mel spectrograms 308”) may individually be provided as output by each acoustic model.

Each thread may provide one of Mel spectrogram 308 to a corresponding neural vocoder (e.g., neural vocoders 309, each an example of neural vocoder 114 of FIG. 1) to generate speech waveforms 310. The speech waveforms 310 may be combined to generate combined speech waveform 312.

The results of employing multi-threading approach 300 indicated a reduction of time over multi-threading approach 200 since each of the phoneme sets had an equal (or substantially equal) number of phonemes. However, when the initial set of phonemes is divided equally (e.g., based on the number of threads available, which may depend on the particular processor(s) of the device on which TTS service 102 executes), it results in mispronunciations for some words due to splitting the phonemes of a word across threads. Here, processing time was reduced but at the cost of pronunciation.

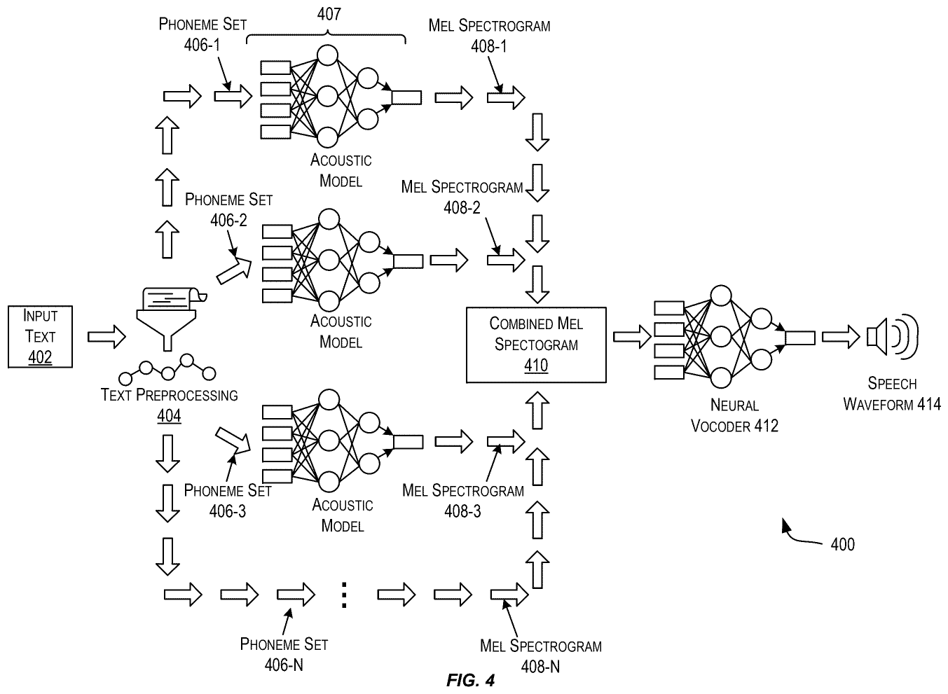

FIG. 4 is a block diagram illustrating a third example of a multi-threading approach 400 to performing Text-To-Speech processing, in accordance with at least one embodiment. The operations discussed in connection with FIG. 4 may be performed by the Text-To-Speech service 102 of FIG. 1. In this example, the preprocessing step may be performed serially, that is, input text 402 may be subjected to text preprocessing 404 (e.g., an example of the operations discussed in connection with text preprocessing 104 of FIG. 1) without being segmented as discussed in FIG. 2.

In some embodiments, the output of text preprocessing 404 may be an initial set of phonemes. This initial set of phonemes may be segmented into equal sized sets (e.g., sets that have the same number of phonemes or, for a set of phonemes that includes an odd number of phonemes, one phoneme segment may include one additional phoneme) including phoneme sets 406-1, 406-2, 406-3, and 406-N, collectively referred to as “phoneme sets 406.”

TTS service 102 may generate/start any suitable number of threads (e.g., separate processes) that may individually provide each set of phoneme sets 406 to a corresponding acoustic model (e.g., acoustic models 407, each an example of the acoustic model 110 of FIG. 1) as input. Mel spectrogram 408-1, 408-2, 408-3, and 408-N (collectively referred to as “Mel spectrograms 408”) may individually be provided as output by each acoustic model.

In this example, the Mel spectrograms 408 may be combined to form combined Mel spectrogram 410. Mel spectrogram 410 may be provided to neural vocoder 412 (e.g., neural vocoders 309, an example of neural vocoder 114 of FIG. 1) to generate output corresponding to speech waveform 414.

The results of employing multi-threading approach 400 resulted in similar mispronunciations due to splitting the initial set of phonemes across threads.

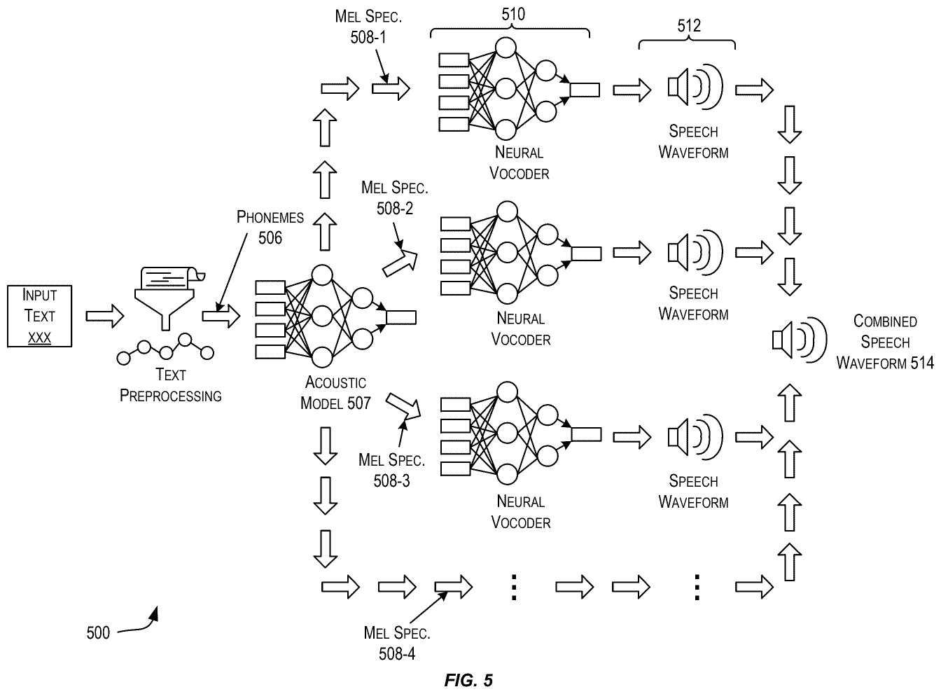

FIG. 5 is a block diagram illustrating a fourth example of a multi-threading approach 500 to performing Text-To-Speech processing, in accordance with at least one embodiment. The operations discussed in connection with FIG. 5 may be performed by the Text-To-Speech service 102 of FIG. 1.

In previous implementations, it was observed that the neural vocoder (e.g., neural vocoder 114 of FIG. 1) appeared to be the bottleneck of the TTS processing pipeline 100 of FIG. 1. When measured, the neural vocoder 114 was taking 70% of the processing time. In this example, the preprocessing step and acoustic model may be performed serially. The multi-threading approach 500 is intended to direct the multi-threading at the neural vocoder level, while text preprocessing 504 and acoustic model 507 are executed serially. In this example, input text 502 may be subjected to text preprocessing 504 (e.g., an example of the operations discussed in connection with text preprocessing 104 of FIG. 1) to generate a set of phonemes (e.g., phonemes 506). Phonemes 506 may be provided to acoustic model 507 (an example of acoustic model 110 of FIG. 1) to generate a Mel spectrogram.

TTS service 102 may split the Mel spectrogram into an equal number of portions (e.g., corresponding to a number of threads available such as 2, 4, 6, or 8, depending on the number and/or type of processor(s) utilized by the computing device on which the TTS service 102 executes). For example, the initial Mel spectrogram may be split into N segments corresponding to Mel spectrograms 508-1, 508-2, 508-3, and 508-N (collectively referred to as “Mel spectrogram segments 508”). Each of the Mel spectrogram segments 508 may be provided to a corresponding neural vocoder of neural vocoders 510 which in turn produces a corresponding speech waveform of speech waveforms 512. Speech waveforms 512 may be combined to form combined speech waveform 514.

Utilizing the multi-threading approach 500 resulted in unparalleled success as the latency of the pipeline was significantly reduced while keeping the quality of the audio intact. The single Mel spectrogram initially produced kept the pronunciations intact and the audio generation by the neural vocoder, which was taking the majority of the inference time and independent of the context, was performed with multiple threads.

When this approach was evaluated, AMOS turned out to be 3.92 as compared to 3.93 for the model without multi-threading while the Word Error Rate (WER) (a ratio of incorrect words to the total number of words) saw a drop from 1.94 to 1.92 for the multi-threading approach 500 and the Character Error Rate (CER) (a ratio of incorrect characters to the total number of characters) also saw a minor drop of 0.05. The traditional serial inference, with an input of 300 characters, at 5 requests per second (RPS) for 10 minutes, deployed on a processor with an x86 instruction set, returned three hundred successful responses. Under the same conditions with multi-threading approach 500 the successful responses increased to four hundred and twenty five successful responses. This is an improvement of 42% over the traditional approach.

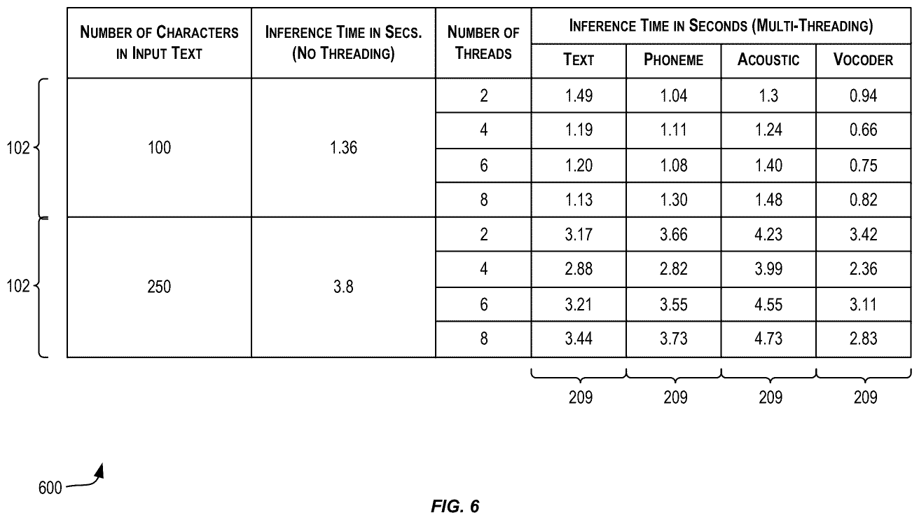

FIG. 6 is a table 600 illustrating example inference times for a number of multi-threading use cases, in accordance with at least one embodiment. Row 602 may correspond to an input text of 100 characters, while row 604 corresponds to an input text of 250 characters. As can be seen in table 600, the inference time with no threading was 1.36 second for input text of 100 characters and 3.8 seconds for input text of 250 characters.

Columns 606, 608, 610, and 612 correspond to inference times in seconds when multi-threading is used with starting at a particular level of the pipeline. For example, column 606 includes inference times corresponding to the example provided in FIG. 2 in which multi-threading was applied at the input text level to generate multiple text segments, each text segment being processed by a corresponding thread. Column 608 includes inference times corresponding to the example provided in FIG. 3 in which multi-threading was applied at the phoneme level where a set of phonemes was split to multiple, equal (or very near equal when an odd number of phonemes is in the initial set) sets of phonemes which are then processed by separate threads. Column 610 includes inference times corresponding to the example of FIG. 4 in which multi-threading was focused at the acoustic model level and the output Mel spectrograms were combined into a single Mel spectrogram before being provided to a neural vocoder as input. Column 612 includes inference times corresponding to the example of FIG. 5 in which multi-threading was focused at the neural vocoder level.

It can be seen from table 600 that the optimal number of threads is four, directed to the vocoder level as these are the entries of table 600 that indicate the shortest latency.

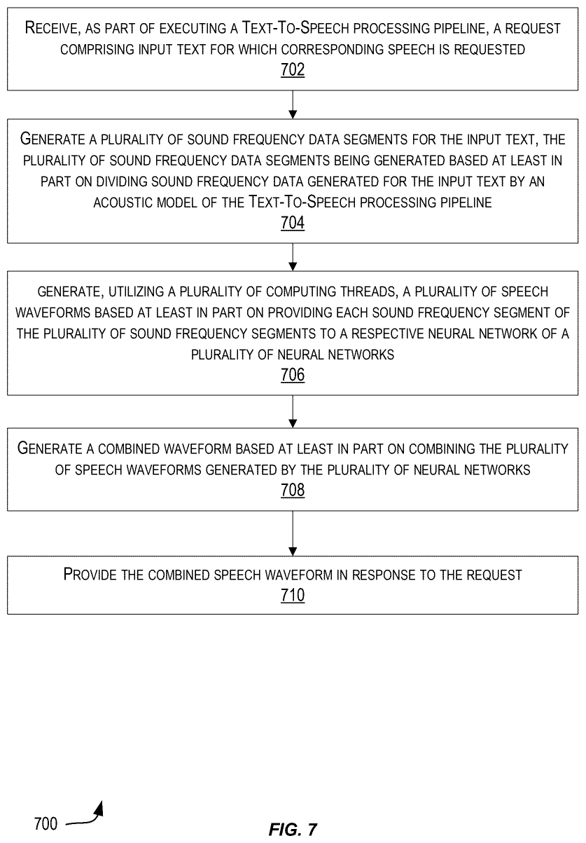

FIG. 7 is a block diagram illustrating an example method 700 for reducing latency in Text-To-Speech (TTS) processing (e.g., processing of Text-To-Speech processing pipeline 100 of FIG. 1), in accordance with at least one embodiment. The method 700 may be performed by Text-To-Speech Service 102 of FIG. 1. In some embodiments, the method 700 may include more or fewer steps than the number depicted in FIG. 7. It should be appreciated that the steps of method 700 may be performed in any suitable order.

The method 700 may begin at 702, where a request comprising input text for which corresponding speech is requested may be received by a service configured to execute a Text-To-Speech processing pipeline (e.g., TTS service 102 of FIG. 1).

At 704, a plurality of sound frequency data segments (e.g., Mel spectrograms 508-1, 508-2, 508-3, and 508-4 of FIG. 5) may be generated for the input text based at least in part on dividing sound frequency data corresponding to the input text (e.g., a Mel spectrogram provided as output from acoustic model 507 of FIG. 5). In some embodiments, the sound frequency data may be generated by an acoustic model of the Text-To-Speech processing pipeline (e.g., acoustic model 507 of FIG. 5). In some embodiments, prior to generating the sound frequency data, the input text may be transformed (e.g., utilizing a set of preprocessing tasks) into a set of sound units (e.g., phonemes 506 of FIG. 5). The set of sound units may be provided as input to the acoustic model, causing the acoustic model to generate the sound frequency data that corresponds to the input text.

At 706, a plurality of speech waveforms (e.g., speech waveforms 512 of FIG. 5) may be generated based at least in part on providing each sound frequency data segment of the plurality of sound frequency data segments to a corresponding neural network of a plurality of neural networks (e.g., neural vocoders 510 of FIG. 5) of the Text-To-Speech processing pipeline.

At 708, a combined speech waveform corresponding to the input text (e.g., combined speech waveform 514 of FIG. 5) may be generated based at least in part on combining the plurality of speech waveforms generated by the plurality of neural networks.

At 710, the combined speech waveform may be provided in response to the request.

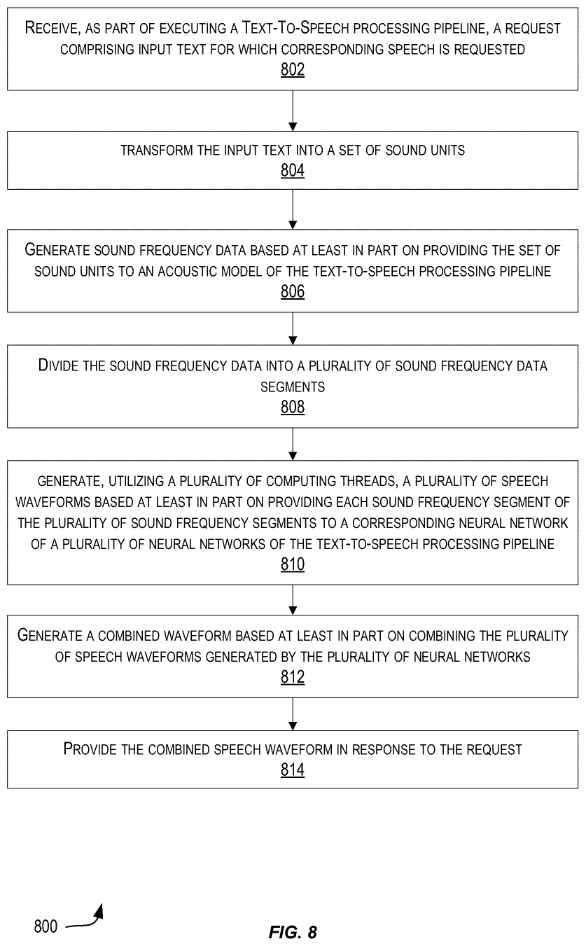

FIG. 8 is a block diagram illustrating another example method 800 for reducing latency in Text-To-Speech (TTS) processing, in accordance with at least one embodiment. The method 800 may be performed by Text-To-Speech Service 102 of FIG. 1. In some embodiments, the method 800 may include more or fewer steps than the number depicted in FIG. 8. It should be appreciated that the steps of method 800 may be performed in any suitable order.

The method 800 may begin at 802, where a request comprising input text for which corresponding speech is requested may be received by a service configured to execute a Text-To-Speech processing pipeline (e.g., TTS service 102 of FIG. 1).

At 804, the input text may be transformed (e.g., utilizing a set of preprocessing tasks) into a set of sound units (e.g., phonemes 506 of FIG. 5).

At 806, sound frequency data (e.g., a Mel spectrogram) may be generated based at least in part on providing the set of sound units (e.g., a set of phonemes) to an acoustic model (e.g., acoustic model 507 of FIG. 5) of the Text-To-Speech processing pipeline.

At 808, the sound frequency data generated at 706 may be divided into a plurality of sound frequency data segments (e.g., smaller Mel spectrograms generated by dividing the Mel spectrogram that was generated at 806). The number of sound frequency data segments in the plurality may correspond to the number of computing threads initiated.

At 810, a plurality of speech waveforms (e.g., speech waveforms 512 of FIG. 5) may be generated based at least in part on providing each sound frequency data segment of the plurality of sound frequency data segments to a corresponding neural network of a plurality of neural networks (e.g., neural vocoders 510 of FIG. 5) of the Text-To-Speech processing pipeline.

At 812, a combined speech waveform corresponding to the input text (e.g., combined speech waveform 514 of FIG. 5) may be generated based at least in part on combining the plurality of speech waveforms generated by the plurality of neural networks.

At 814, the combined speech waveform may be provided in response to the request.

### Infrastructure as a Service Example Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

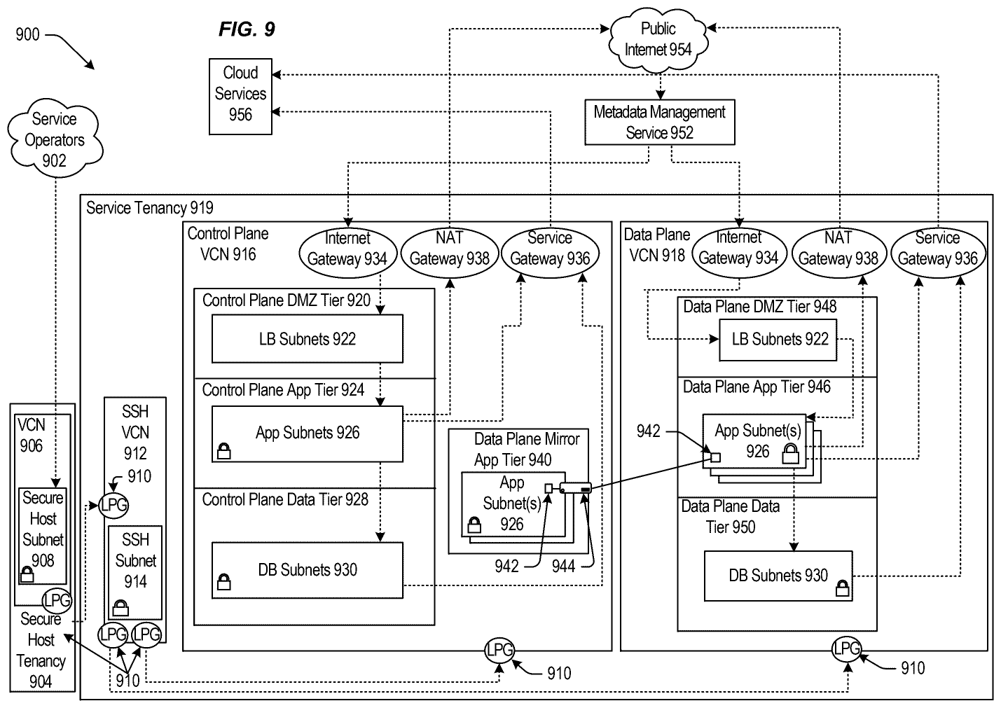

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users′, or other customers′, resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

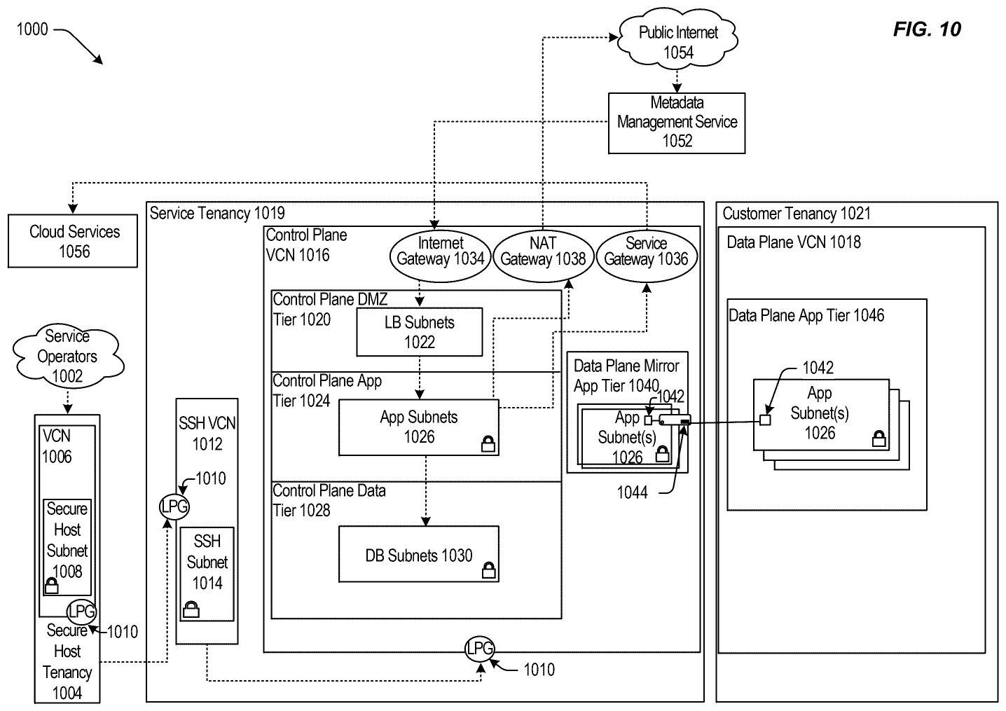

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

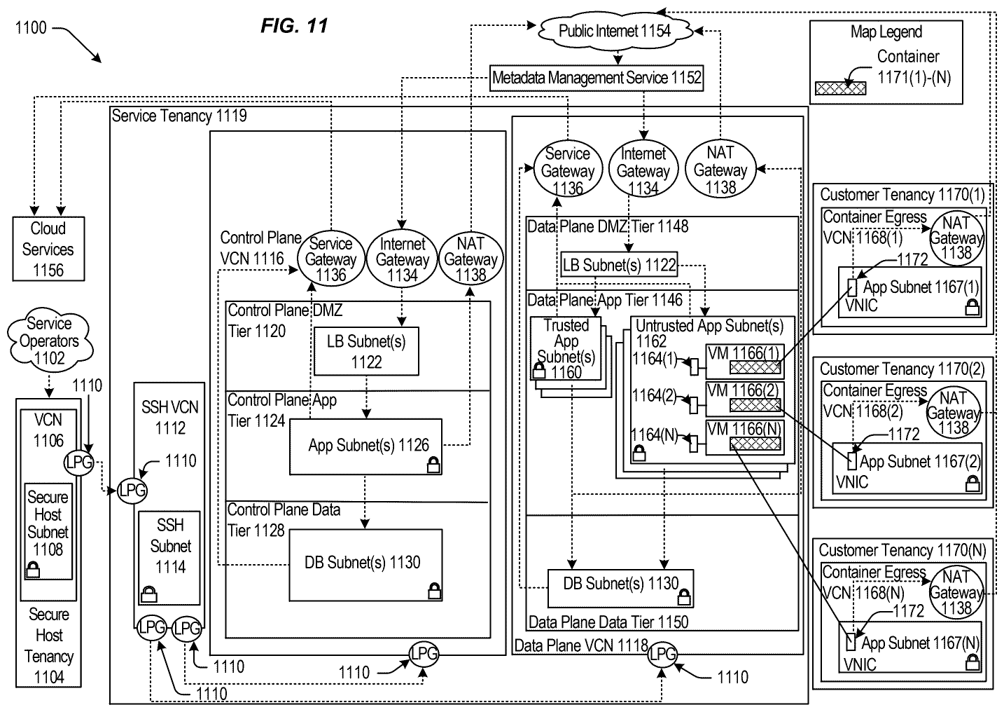

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

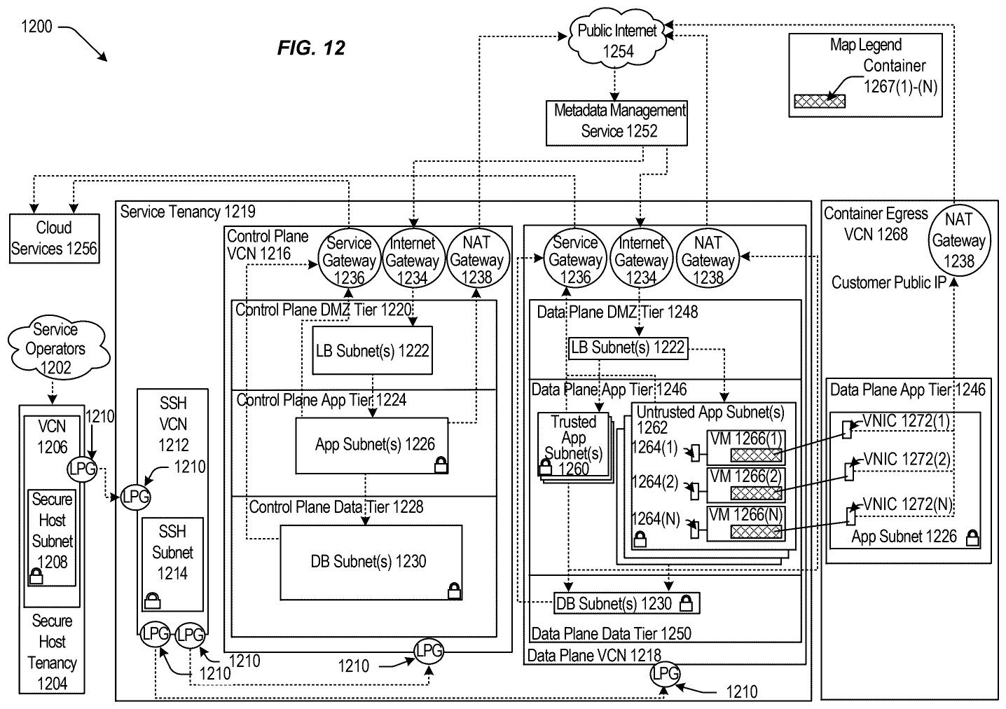

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N) and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

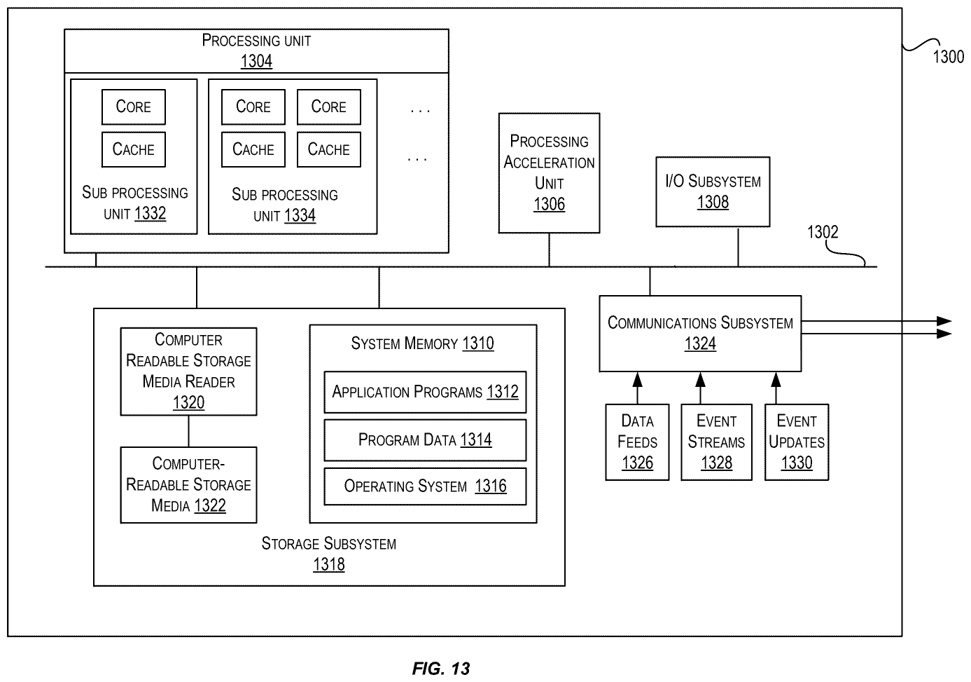

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving, by a computing system configured to execute a Text-To-Speech processing pipeline, a request comprising input text for which corresponding speech is requested;
generating, by the computing system, a plurality of sound frequency data segments, the plurality of sound frequency data segments being generated based at least in part on dividing sound frequency data generated for the input text by an acoustic model of the Text-To-Speech processing pipeline;
generating, by the computing system utilizing a plurality of computing threads, a plurality of speech waveforms from the plurality of sound frequency data segments based at least in part on providing each sound frequency data segment of the plurality of sound frequency data segments to a respective neural network of a plurality of neural networks;
generating, by the computing system, a combined speech waveform based at least in part on combining the plurality of speech waveforms that were generated by the plurality of neural networks; and
providing, by the computing system, the combined speech waveform in response to the request.

2. The computer-implemented method of claim 1, further comprising generating a set of sound units from the input text, the set of sound units being generated based at least in part on executing a set of preprocessing tasks comprising at least one of a text normalization process or a grapheme-to-phoneme conversion process.

3. The computer-implemented method of claim 2, wherein the set of sound units are a set of phonemes.

4. The computer-implemented method of claim 1, wherein the plurality of neural networks are a plurality of instances of a neural vocoder, the neural vocoder being a machine-learning model previous trained to take a Mel spectrogram as input and generate a corresponding speech waveform as output, the corresponding speech waveform, when played, comprising corresponding speech of at least a portion of the input text.

5. The computer-implemented method of claim 1, wherein each sound frequency data segment of the plurality of sound frequency data segments is provided to the respective neural network of the plurality of neural networks optimally utilizing a respective computing thread of the plurality of computing threads, and wherein providing each sound frequency data segment utilizing the respective computing thread reduces an overall latency of executing the Text-To-Speech processing pipeline.

6. The computer-implemented method of claim 1, wherein the sound frequency data is a Mel spectrogram generated by the acoustic model, and wherein the plurality of sound frequency data segments comprise a plurality of Mel spectrograms obtained based at least in part on dividing the Mel spectrogram into segments.

7. The computer-implemented method of claim 1, wherein a quantity of the plurality of computing threads is identified prior to initiating the plurality of computing threads, the quantity being identified based at least in part on a number or type of the one or more processors that are utilized by the computing system.

8. A system configured to execute a Text-To-Speech processing pipeline, the system comprising:
one or more processors; and
one or more non-transitory memories storing computer-readable instructions that, when executed, cause the one or more processors to:
receive a request comprising input text for which corresponding speech is requested;
generate a plurality of sound frequency data segments, the plurality of sound frequency data segments being generated based at least in part on dividing sound frequency data previously generated for the input text by an acoustic model of the Text-To-Speech processing pipeline;
generate, utilizing a plurality of computing threads, a plurality of speech waveforms from the plurality of sound frequency data segments based at least in part on providing each sound frequency data segment of the plurality of sound frequency data segments to a respective neural network of a plurality of neural networks;
generate a combined speech waveform based at least in part on combining the plurality of speech waveforms that were generated by the plurality of neural networks; and
provide the combined speech waveform in response to the request.

9. The system of claim 8, further comprising generating a set of sound units from the input text, the set of sound units being generated based at least in part on executing a set of preprocessing tasks comprising at least one of a text normalization process or a grapheme-to-phoneme conversion process.

10. The system of claim 9, wherein the set of sound units are a set of phonemes.

11. The system of claim 8, wherein the plurality of neural networks are a plurality of instances of a neural vocoder, the neural vocoder being a machine-learning model previous trained to take a Mel spectrogram as input and generate a corresponding speech waveform as output, the corresponding speech waveform, when played, comprising corresponding speech of at least a portion of the input text.

12. The system of claim 8, wherein each sound frequency data segment of the plurality of sound frequency data segments is provided to the respective neural network of the plurality of neural networks optimally utilizing a respective computing thread of the plurality of computing threads, and wherein providing each sound frequency data segment utilizing the respective computing thread reduces an overall latency of executing the Text-To-Speech processing pipeline.

13. The system of claim 8, wherein the sound frequency data is a Mel spectrogram generated by the acoustic model, and wherein the plurality of sound frequency data segments comprise a plurality of Mel spectrograms obtained based at least in part on dividing the Mel spectrogram into segments.

14. The system of claim 8, wherein a quantity of the plurality of computing threads is identified prior to initiating the plurality of computing threads, the quantity being identified based at least in part on a number or type of the one or more processors that are utilized by the system.

15. A non-transitory computer-readable medium configured to store computer-executable instructions that, when executed by a computer system configured to execute a Text-To-Speech processing pipeline, causes the computer system to:
receive a request comprising input text for which corresponding speech is requested;
generate a plurality of sound frequency data segments, the plurality of sound frequency data segments being generated based at least in part on dividing sound frequency data previously generated for the input text by an acoustic model of the Text-To-Speech processing pipeline;
generate, utilizing a plurality of computing threads, a plurality of speech waveforms from the plurality of sound frequency data segments based at least in part on providing each sound frequency data segment of the plurality of sound frequency data segments to a respective neural network of a plurality of neural networks;
generate a combined speech waveform based at least in part on combining the plurality of speech waveforms that were generated by the plurality of neural networks; and
provide the combined speech waveform in response to the request.

16. The non-transitory computer-readable medium of claim 15, further comprising generating a set of sound units from the input text, the set of sound units being generated based at least in part on executing a set of preprocessing tasks comprising at least one of a text normalization process or a grapheme-to-phoneme conversion process.

17. The non-transitory computer-readable medium of claim 15, wherein the plurality of neural networks are a plurality of instances of a neural vocoder, the neural vocoder being a machine-learning model previous trained to take a Mel spectrogram as input and generate a corresponding speech waveform as output, the corresponding speech waveform, when played, comprising corresponding speech of at least a portion of the input text.

18. The non-transitory computer-readable medium of claim 15, wherein each sound frequency data segment of the plurality of sound frequency data segments is provided to the respective neural network of the plurality of neural networks optimally utilizing a respective computing thread of the plurality of computing threads, and wherein providing each sound frequency data segment utilizing the respective computing thread reduces an overall latency of executing the Text-To-Speech processing pipeline.

19. The non-transitory computer-readable medium of claim 15, wherein the sound frequency data is a Mel spectrogram generated by the acoustic model, and wherein the plurality of sound frequency data segments comprise a plurality of Mel spectrograms obtained based at least in part on dividing the Mel spectrogram into segments.

20. The non-transitory computer-readable medium of claim 15, wherein a quantity of the plurality of computing threads is identified prior to initiating the plurality of computing threads, the quantity being identified based at least in part on a number or type of the one or more processors that are utilized by the computing system.
